(19) United States
(12) Patent Application Publication
(10) Pub. No.: US 2017/0003530 A1
(43) Pub. Date: Jan. 5, 2017

(54) LIQUID CRYSTAL DISPLAY DEVICE

(71) Applicant: Japan Display Inc., Minato-ku (JP)

(72) Inventor: Jin HIROSAWA, Tokyo (JP)

(73) Assignee: Japan Display Inc., Minato-ku (JP)

(21) Appl. No.: 15/189,724

(22) Filed: Jun. 22, 2016

(30) Foreign Application Priority Data
Jul. 3, 2015 (JP) 2015-134292

(51) Int. Cl. G02F 1/1368; G02F 1/1339; G02F 1/1343; G02F 1/1362; G02F 1/1333

(52) U.S. Cl. CPC G02F 1/1368; G02F 1/136286; G02F 1/133345; G02F 1/134363; G02F 1/1339; G02F 2201/121; G02F 2201/123

(57) ABSTRACT

According to one embodiment, a liquid crystal display device, includes a first substrate including first and second gate lines, a first electrode, and a second electrode, the second electrode including first to fourth edges, the first and second gate lines extending in a first direction, the first and second edges extending in a first extending direction, the third and four edges extending in a second extending direction, the first and second extending directions being in a same orientation and intersecting the first direction at an acute angle, a first angle between the first direction and the first extending direction being greater than a second angle between the first direction and the second extending direction.

### CROSS-REFERENCE TO RELATED APPLICATIONS

This application is based upon and claims the benefit of priority from Japanese Patent Application No. 2015-134292, filed Jul. 3, 2015, the entire contents of which are incorporated herein by reference.

### FIELD

Embodiments described herein relate generally to a liquid crystal display device.

### BACKGROUND

Recently, liquid crystal display devices of the lateral electric field mode have been put into practical use. In the lateral electric field mode, liquid crystal molecules are rotated in a plane parallel to an array substrate by using an electric field formed between a pixel electrode and a common electrode on the array substrate, to control the transmittance. Incidentally, if regions in which directions of rotation of liquid crystal molecules are opposite to each other exist together, the alignment restriction force for the liquid crystal molecules is degraded, and non-uniformity in display may occur when a stress is applied from the outside. For example, technology of forming a protruding portion at a pixel electrode, forming a region where a reverse domain is generated by concentrating an electric field, and fixing the reverse domain to a region shielded from light by a light-shielding layer is disclosed.

In contrast, requirement for higher definition is recently increased and the pixel pitch tends to be smaller. For this reason, maintaining a sufficient interval between the protruding portion formed at the pixel electrode and an adjacent electrode to suppress a short circuit becomes difficult.

### BRIEF DESCRIPTION OF THE DRAWINGS

FIG. 1 is an illustration schematically showing a configuration of a display panel PNL constituting a liquid crystal display device of the embodiments.

FIG. 2 is a plan view showing a configuration example of the pixel PX on the array substrate AR shown in FIG. 1.

FIG. 3 is a cross-sectional view showing the array substrate AR seen along line A-B of FIG. 2.

FIG. 4 is a cross-sectional view showing the display panel PNL seen along line C-D of FIG. 2.

FIG. 5 is a plan view showing a configuration example of two pixels arranged in the second direction Y.

FIG. 6 is an illustration for explanation of operations of the liquid crystal display device of the embodiments.

FIG. 7 is an illustration for explanation of operations of the liquid crystal display device of the embodiments.

FIG. 8 is a plan view showing another configuration example of the pixel PX on the array substrate AR shown in FIG. 1.

FIG. 9 is a cross-sectional view showing the array substrate AR seen along line A-B of FIG. 8.

FIG. 10 is a cross-sectional view showing the display panel PNL seen along line C-D of FIG. 8.

FIG. 11 is another cross-sectional view showing the display panel PNL seen along line C-D of FIG. 8.

### DETAILED DESCRIPTION

In general, according to one embodiment, a liquid crystal display device, includes: a first substrate including a first gate line and a second gate line, a first source line and a second source line intersecting the first gate line and the second gate line, respectively, a first interlayer insulating film disposed above the first gate line, the second gate line, the first source line and the second source line, a first electrode located above the first interlayer insulating film, a second interlayer insulating film disposed above the first electrode, and a second electrode located above the second interlayer insulating film and opposed to the first electrode; a second substrate opposed to the first substrate; and a liquid crystal layer held between the first substrate and the second substrate, the second electrode including an outer peripheral edge including a first edge located on the first source line side, a second edge located on the second source line side, a third edge located on the first gate line side, and a fourth edge located on the second gate line side, the first gate line and the second gate line extending in a first direction, the first edge and the second edge extending in a first extending direction, the third edge and the four edge extending in a second extending direction, the first extending direction and the second extending direction being in a same orientation and intersecting the first direction at an acute angle, a first angle between the first direction and the first extending direction being greater than a second angle between the first direction and the second extending direction.

According to another embodiment, a liquid crystal display device, includes: a first substrate including a first gate line and a second gate line parallel to each other, and a second electrode located between the first gate line and the second gate line; a second substrate opposed to the first substrate; and a liquid crystal layer held between the first substrate and the second substrate, the second electrode including an outer peripheral edge including a first edge and a second edge parallel to each other, a third edge connected to the first edge and the second edge and located on the first gate line side, and a fourth edge connected to the first edge and the second edge and located on the second gate line side, the third edge and the fourth edge being parallel to each other and nonparallel to the first gate line and the second gate line.

Embodiments are described hereinafter with reference to accompanying drawings. The disclosure is merely an example, and proper changes in keeping with the spirit of the invention, which are easily conceivable by a person of ordinary skill in the art, come within the scope of invention as a matter of course. In addition, in some cases, in order to make the description clearer, the widths, thicknesses, shapes, and the like of each element are illustrated in the drawings schematically, rather than as an accurate representation of what is implemented. However, such schematic illustration is merely exemplary, and in no way restricts the interpretation of the present application. In addition, in the specification and drawings, constituent elements which function in the same or similar manner to those described in connection with preceding drawings are denoted by like reference numbers, their detailed description being omitted unless necessary.

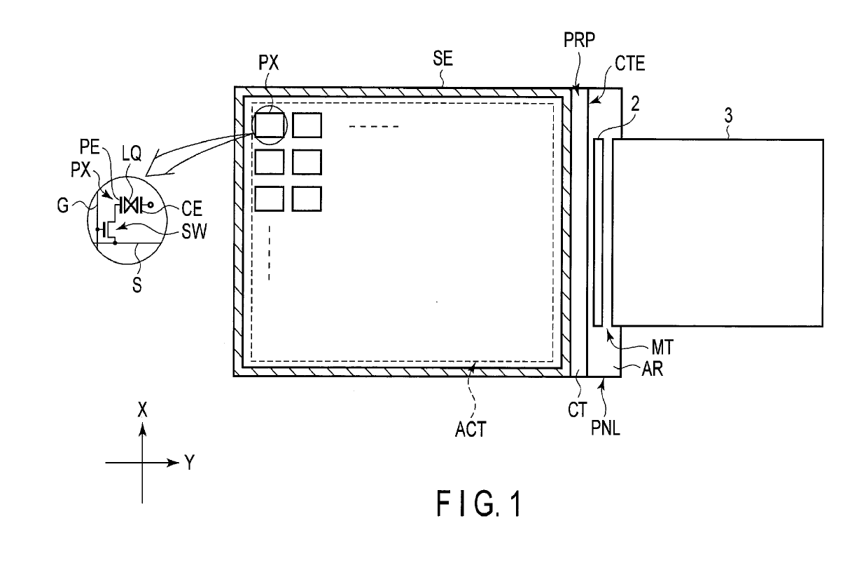

FIG. 1 is an illustration schematically showing a configuration of a display panel PNL constituting a liquid crystal display device of the embodiments.

The display panel PNL includes an array substrate (first substrate) AR, a counter-substrate (second substrate) CT arranged to be opposed to the array substrate AR, and a liquid crystal layer LQ held between the array substrate AR and the counter-substrate CT. The array substrate AR and the counter-substrate CT are applied to each other by a sealing member SE while forming a predetermined gap between the substrates. The liquid crystal layer LQ is held on an inner side surrounded by the sealing member SE, in the gap formed between the array substrate AR and the counter-substrate CT. The display panel PNL includes an active area (display area) ACT on which an image is displayed, on the inner side surrounded by the sealing member SE. The active area ACT is composed of pixels PX arrayed in a matrix.

The array substrate AR includes, in an active area ACT, gate lines G extending in a first direction X, source lines S extending in a second direction Y intersecting the first direction X, switching elements SW electrically connected to the gate lines G and the source lines S in the respective pixels PX, pixel electrodes PE electrically connected to the switching elements SW in the respective pixels PX, and the like. In the example illustrated, the first direction X and the second direction Y are orthogonal to each other. Common electrodes CE of a common potential are arranged on the array substrate AR or the counter-substrate CT and are opposed to the pixel electrodes PE. The gate lines G may not be formed in a straight line parallel to the first direction X, and the source lines S may not be formed in a straight line parallel to the second direction Y. In other words, the gate lines G and the source lines S may be bent or partially branched.

Signal supply sources necessary to drive the display panel PNL, such as a driving IC chip 2 and a flexible printed circuit (FPC) 3, are located in a peripheral area (non-display area) PRP outside the active area ACT. In the example illustrated, the driving IC chip 2 and the FPC 3 are mounted on a mounting portion MT of the array substrate AR extending to an outer side than a substrate end portion CTE of the counter-substrate CT.

Details of the configuration of the display panel PNL are not explained, but the pixel electrodes PE are arranged in the array substrate AR while the common electrodes CE are arranged in the counter-substrate CT, in a display mode using a longitudinal field along the normal direction of the X-Y plane or the main surface of the substrate or a display mode using an oblique electric field angled with respect to the normal direction of the main surface of the substrate. In addition, the pixel electrodes PE and the common electrodes CE are disposed on the array substrate AR, in a display mode using a lateral electric field along the main surface of the substrate. Furthermore, the display panel PNL may have a configuration compatible with a display mode using an arbitrary combination of the longitudinal, lateral and oblique electric fields.

The display panel PNL is a transmissive display panel having a transmissive display function of displaying an image by, for example, allowing the light from a backlight unit BL which will be explained later to be selectively transmitted, but is not limited to this. The display panel PNL may be a reflective display panel having a reflective display function of displaying an image by allowing the light from the display surface side such as external light and auxiliary light to be selectively reflected. In addition, the display panel PNL may be a transflective display panel having the transmissive display function and the reflective display function.

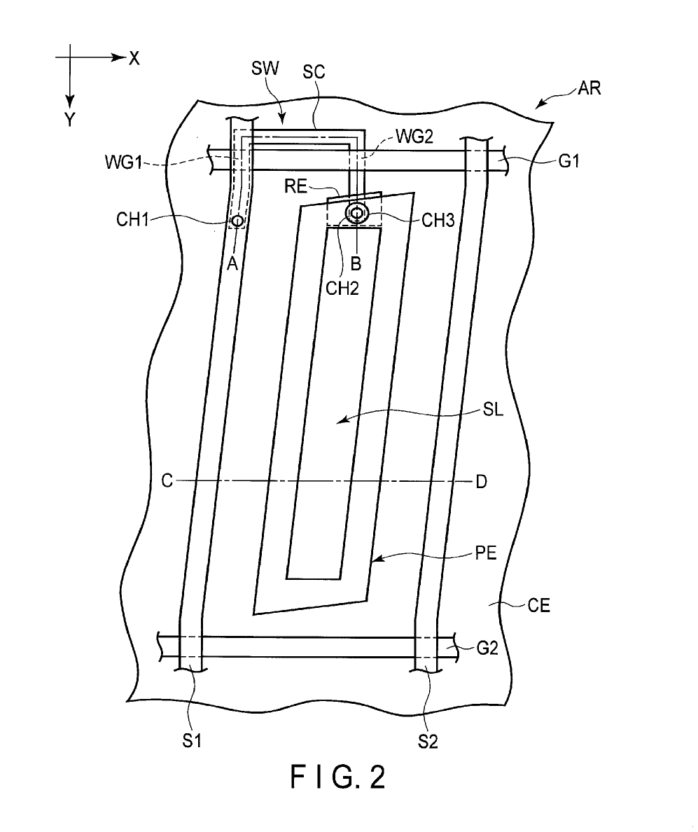

FIG. 2 is a plan view showing a configuration example of the pixel PX on the array substrate AR shown in FIG. 1. The pixel structure of the display panel PNL to which one of the lateral electric field modes, i.e., the fringe field switching (FFS) mode is applied as an example of the display mode, will be explained.

The array substrate AR includes gate lines G1 and G2, source lines S1 and S2, a switching element SW, a pixel electrode PE, a common electrode CE and the like.

The gate lines G1 and G2 extend along the first direction X so as to be arranged in the second direction Y and spaced apart from each other. The source lines S1 and S2 extend substantially along the second direction Y so as to be arranged in the first direction X and spaced apart from each other. The gate lines G1 and G2 intersect the source lines S1 and S2.

The switching element SW is located near an intersection of the gate line G1 and the source line S1 and electrically connected with the gate line G1 and the source line S1. The switching element SW includes a semiconductor layer SC. The switching element SW of the example illustrated is in a double-gate structure comprising gate electrodes WG1 and WG2. Each of the gate electrodes WG1 and WG2 is a part of the gate line G1 opposed to the semiconductor layer SC. One of ends of the semiconductor layer SC is electrically connected with the source line S1 while the other end of the semiconductor layer SC is electrically connected with the pixel electrode PE. The source line S1 is in contact with one of end sides of the semiconductor layer SC through a contact hole CH1. A relay electrode RE is located between the pixel electrode PE and the other end side of semiconductor layer SC. The relay electrode RE is in contact with the other end side of the semiconductor layer SC through a contact hole CH2. The pixel electrode PE is in contact with the relay electrode RE through a contact hole CH3.

The common electrode CE is formed to be opposed not only to the gate lines G1 and G2, the source lines S1 and S2 and the switching element SW, but also to the pixel electrode PE. For example, the common electrode CE is disposed on an upper layer side than the gate lines G1 and G2, the source lines S1 and S2 and the switching element SW, and disposed on a lower layer side than the pixel electrode PE. The upper layer side corresponds to a side of the array substrate AR which is close to the liquid crystal layer LQ to be explained later, and the lower layer side corresponds to a side of the array substrate AR which is close to the first insulating substrate 10 to be explained later. The pixel electrode PE is formed in a loop shape. In other words, a slit SL is formed in the pixel electrode PE so as to be opposed to the common electrode CE. The slit SL extends in a direction different from the first direction X and the second direction Y and, for example, extends substantially parallel to the source lines S1 and S2. One slit SL is formed in the pixel electrode PE in the example illustrated, but two or more slits SL may be formed. The shape of the pixel electrode PE will be explained later in detail.

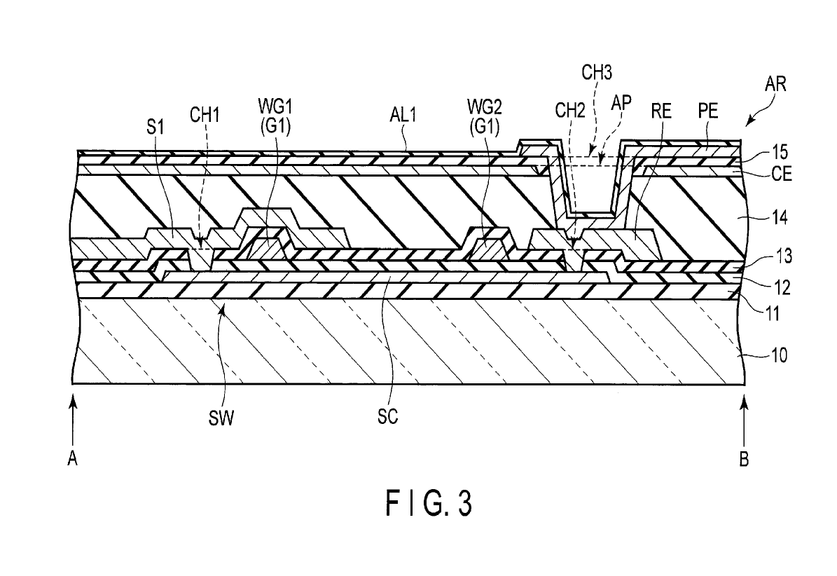

FIG. 3 is a cross-sectional view showing the array substrate AR seen along line A-B of FIG. 2.

The array substrate AR is formed by using the first insulating substrate 10 having a light transmitting property such as a glass substrate or a resin substrate. The array substrate AR includes a first insulating film 11, a second insulating film 12, a third insulating film 13, a fourth insulating film 14, a fifth insulating film 15, the switching element SW, the pixel electrode PE, the common electrode CE, a first alignment film AL1 and the like. The switching element SW is in a top-gate type in the example illustrated, but may be in a bottom-gate type. In addition, in the example illustrated, the switching element SW is composed of a double-gate type thin film transistor, but may be composed of a single-gate type thin film transistor.

The first insulating film 11 is formed on the first insulating substrate 10. The semiconductor layer SC of the switching element SW is formed on the first insulating film 11. The semiconductor layer SC is formed of, for example, polycrystalline silicon, but may be formed of amorphous silicon, an oxide semiconductor or the like.

The second insulating film 12 is formed on the first insulating film 11 and the semiconductor layer SC. The gate electrodes WG1 and WG2 which are parts of the gate line G1 are formed on the second insulating film 12 and opposed to the semiconductor layer SC. The third insulating film 13 is formed on the gate electrodes WG1 and WG2 and the second insulating film 12. The source line S1 and the relay electrode RE are formed on the third insulating film 13. The source line S1 is in contact with the semiconductor layer SC through the contact hole CH1 which penetrates the second insulating film 12 and the third insulating film 13. The relay electrode RE is in contact with the semiconductor layer SC through the contact hole CH2 which penetrates the second insulating film 12 and the third insulating film 13.

The fourth insulating film 14 is formed on the third insulating film 13, the source line S1 and the relay electrode RE. The common electrode CE is formed on the fourth insulating film 14. The common electrode CE includes an opening portion AP at a position opposed to the relay electrode RE. The fifth insulating film 15 is formed on the fourth insulating film 14 and the common electrode CE. The first insulating film 11, the second insulating film 12, the third insulating film 13, and the fifth insulating film 15 are formed of, for example, an inorganic material such as a silicon nitride (SiN) or a silicon oxide (SiO). The fourth insulating film 14 is formed of, for example, an organic material such as an acrylic resin.

The pixel electrode PE is formed on the fifth insulating film 15. The pixel electrode PE is in contact with the relay electrode RE through the contact hole CH3 which penetrates the fourth insulating film 14 and the fifth insulating film 15. The common electrode CE and the pixel electrode PE are formed of, for example, a transparent, electrically conductive material such as indium zinc oxide (IZO) or indium tin oxide (ITO). The first alignment film AL1 is formed on the fifth insulating film 15 and the pixel electrode PE. The first alignment film AL1 is formed of, for example, a material having a horizontal alignment property.

In the example illustrated, the fourth insulating film 14 corresponds to a first interlayer insulating film, the fifth insulating film 15 corresponds to a second interlayer insulating film, the common electrode CE corresponds to a first electrode, and the pixel electrode PE corresponds to a second electrode.

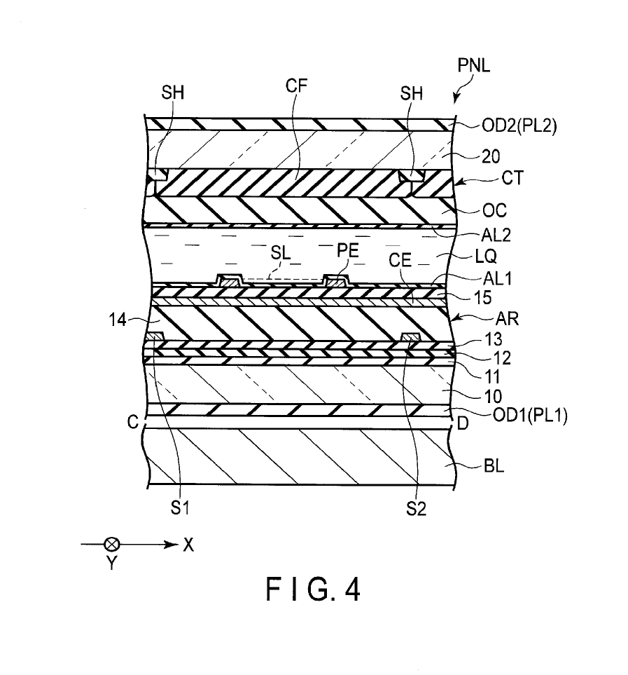

FIG. 4 is a cross-sectional view showing the display panel PNL seen along line C-D of FIG. 2.

In the array substrate AR, the source lines S1 and S2 are formed on the third insulating film 13 and covered with the fourth insulating film 14. The common electrode CE is formed on the fourth insulating film 14 and covered with the fifth insulating film 15. The common electrode CE extends not only to a position opposed to the source lines S1 and S2, but also to a position opposed to the switching element and gate lines (not shown). The pixel electrode PE is formed on the fifth insulating film 15, located on an inner side than a position just above the source lines S1 and S2, opposed to the common electrode CE, and covered with the first alignment film AL1.

The counter-substrate CT is formed by using a second insulating substrate 20 having a light transmitting property such as a glass substrate or a resin substrate. The counter-substrate CT includes a light-shielding layer SH, color filters CF, an overcoat layer OC, a second alignment film AL2 and the like on a side opposed to the array substrate AR.

The light-shielding layer SH is formed on a side of the second insulating substrate 20 which is opposed to the array substrate AR. The light-shielding layer SH is formed not only at a position opposed to the source lines S1 and S2, but also at a position opposed to the switching element and the gate lines (not shown). The color filters CF are opposed to the pixel electrode PE. End portions of the color filters CF are overlaid on the light-shielding layer SH. Each of the color filters CF is formed of a resin material colored in, for example, any one of red, green and blue. The color filters arranged in the first direction X are formed of resin materials colored in different colors. The color filters CF may include a white color filter or a transparent color filter. The overcoat layer OC is formed of a transparent resin material and covers the color filters CF. The second alignment film AL2 is formed on a side of the overcoat layer OC which is opposed to the array substrate AR. The alignment film AL2 is formed of a material having a horizontal alignment property. In the example illustrated, the color filters CF are formed in the counter-substrate CT, but may be formed in the array substrate AR.

The array substrate AR and the counter-substrate CT as explained above are disposed such that the first alignment film AL1 and the second alignment film AL2 face each other. At this time, a predetermined cell gap is formed between the array substrate AR and the counter-substrate CT. The array substrate AR and the counter-substrate CT are applied to each other by a sealing member SE while forming the cell gap between the substrates. The liquid crystal layer LQ is sealed between the first alignment film AL1 of the array substrate AR and the second alignment film AL2 of the counter-substrate CT. The liquid crystal layer LQ is composed of a liquid crystal material of a negative dielectric anisotropy or a liquid crystal material of a positive dielectric anisotropy.

A backlight unit BL is disposed on a back surface side of the display panel PNL thus configured. Various types of units are applicable as the backlight unit BL, but explanation of details of the structure is omitted.

A first optical element OD1 including a first polarizer PL1 is disposed on the outer surface of the first insulating substrate 10. A second optical element OD2 including a second polarizer PL2 is disposed on the outer surface of the second insulating substrate 20. A first polarization axis of the first polarizer PL1 and a second polarization axis of the second polarizer PL2 are located to have, for example, a crossed-Nicol relationship in the X-Y plane.

Next, the pixel electrodes, gate lines G1 to G3, and the source lines S1 and S2 will be explained with reference to two pixels arranged in the second direction Y. The pixels arranged in the second direction Y are pixels exhibiting the same color and, though not explained in detail, the pixels are opposed to the color filters of the same color.

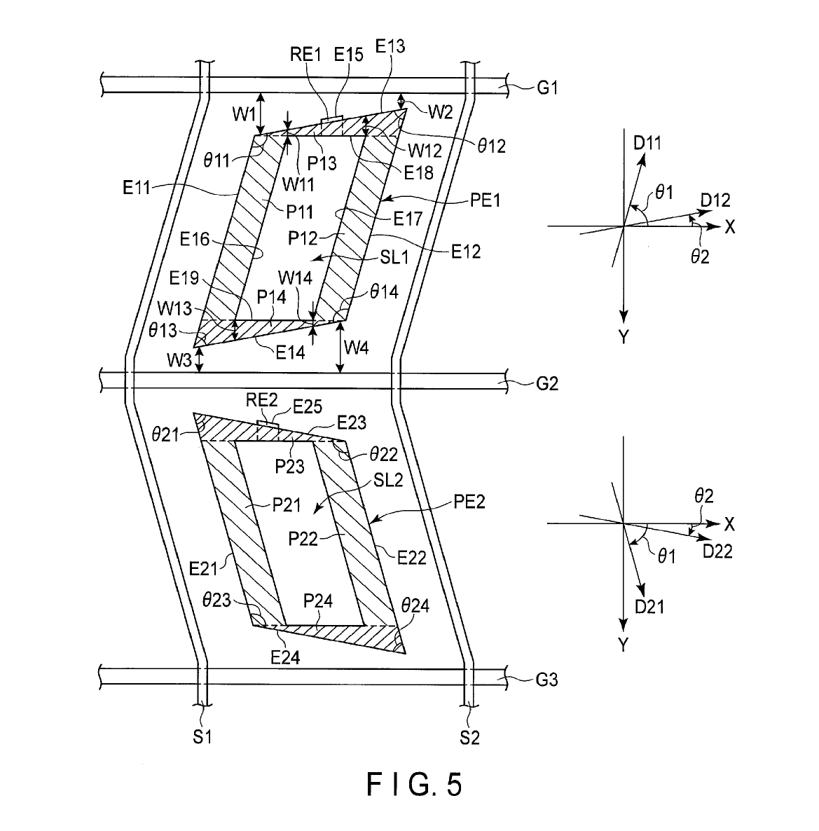

FIG. 5 is a plan view showing a configuration example of two pixels arranged in the second direction Y.

First, the configuration will be explained with reference to a pixel electrode PE1 surrounded by the gate lines G1 and G2, and the source lines S1 and S2. Illustration of the common electrode is omitted.

The pixel electrode PE1 comprises a first edge E11 located on the source line S1 side, a second edge E12 located on the source line S2 side, a third edge E13 located on the gate line G1 side, and a fourth edge E14 located on the gate line G2 side. The first edge E11 and the second edge E12 are arranged in the first direction X to be spaced apart from each other, and are parallel to each other. The third edge E13 and the fourth edge E14 are arranged in the second direction Y to be spaced apart from each other, and are parallel to each other. The first to fourth edges E11 to E14 correspond to, for example, outer peripheral edges of the pixel electrode PE1.

The first edge E11 and the second edge E12 extend in a first extending direction D11. The third edge E13 and the fourth edge E14 are nonparallel to the gate lines G1 and G2, respectively, and extend in a second extending direction D12. The first extending direction D11 and the second extending direction D12 are directions intersecting the first direction X in which the gate lines G1 and G2 extend, at an acute angle counterclockwise. A first angle θ1 formed between the first direction X and the first extending direction D11 is greater than a second angle θ2 formed between the first direction X and the second extending direction D12.

A first interval W1 on the source line S1 side between the gate line G1 and the third edge E13 is greater than a second interval W2 on the source line S2 side between the gate line G1 and the third edge E13. In addition, a third interval W3 on the source line S1 side between the gate line G2 and the fourth edge 514 is greater than a fourth interval W4 on the source line S2 side between the gate line G2 and the fourth edge E14. The first to fourth intervals W1 to W4 are the distances along the second direction Y. The source lines S1 and S2 extend in the first extending direction D11, at positions on both sides sandwiching the pixel electrode PE1. An interval along the first direction X between the source line S1 and the first edge E11 is equal to an interval along the first direction X between the source line S2 and the second edge 512.

The pixel electrode PE1 will be explained hereinafter in more detail. The pixel electrode PE1 includes a first portion P11 including the first edge E11, a second portion P12 including the second edge E12, a third portion P13 including the third edge E13, and a fourth portion P14 including the fourth edge E14. In the drawing, the first portion P11 and the second portion P12 correspond to portions represented by oblique lines downward to the right side, and the third portion P13 and the fourth portion P14 correspond to portions represented by oblique lines upward to the right side. End portions of the third portion P13 are connected to the first portion P11 and the second portion P12, respectively. Similarly, end portions of the fourth portion P14 are connected to the first portion P11 and the second portion P12, respectively. The pixel electrode PE1 is formed in a loop shape as explained above and includes a slit SL1. A longer axis of the slit SL1 extends in the first extending direction D11.

The first portion P11 and the second portion P12 are arranged in the first direction X to be spaced apart from each other, and extend in the first extending direction D11. Widths along the first direction X, of the first portion P11 and the second portion P12, are substantially equal to each other. The third portion P13 and the fourth portion P14 extend in the first direction X or the second extending direction D12. The width in the second direction Y, of the third portion P13, is increased from the source line S1 side toward the source line S2 side in the first direction X. For example, a first width W11 on the source line S1 side, of the third portion P13 illustrated, is smaller than a second width W12 on the source line S2 side, of the third portion P13. The width in the second direction Y, of the fourth portion P14, is increased from the source line S1 side toward the source line S2 side in the first direction X. For example, a third width W13 on the source line S1 side, of the fourth portion P14 illustrated, is greater than a fourth width W14 on the source line S2 side, of the fourth portion P14.

In the example illustrated, the first edge E11 entirely extends straight along the first extending direction D11 without protruding toward the source line S1 side, and end portions of the first edge E11 are connected to the third edge E13 and the fourth edge E14, respectively. The second edge E12 entirely extends straight along the first extending direction D11 without protruding toward the source line S2 side, and end portions of the second edge E12 are connected to the third edge E13 and the fourth edge E14, respectively.

In other words, none of the third portion P13 and the fourth portion P14 of the pixel electrode PE1 protrudes toward the side close to the source line S1 beyond the first portion P11 or protrudes toward the side close to the source line S2 beyond the second portion P12.

The pixel electrode PE1 includes a first interior angle θ11 formed between the first edge E11 and the third edge E13, a second interior angle θ12 formed between the second edge E12 and the third edge E13, a third interior angle θ13 formed between the first edge E11 and the fourth edge E14, and a fourth interior angle θ14 formed between the second edge E12 and the fourth edge E14. The first interior angle θ11 and the fourth interior angle θ14 are obtuse angles while the second interior angle θ12 and the third interior angle θ13 are acute angles. For example, the first interior angle θ11 and the fourth interior angle θ14 are equal to each other while the second interior angle θ12 and the third interior angle θ13 are equal to each other. In other words, the first to fourth edges E11 to E14 forming an outer peripheral edge of the pixel electrode PE1 form a parallelogram in the X-Y plane.

It should be noted that intersections formed by the first edge E11, and the third edge E13 and the fourth edge E14 may be rounded and that intersections formed by the second edge E12, and the third edge E13 and the fourth edge E14 may be rounded. In other words, the first to fourth edges E11 to E14 may be connected to each other via curved edges. Such a shape also corresponds to the embodiments if extensions of the first edge E11 and the second edge E12 intersect extensions of the third edge E13 and the fourth edge E14 at the first to fourth interior angles θ11 to θ14.

In the pixel electrode PE1, the third portion P13 is opposed to a relay electrode RE1 in the X-Y plane and is in contact with the relay electrode as explained with reference to FIG. 3. The relay electrode RE1 includes a fifth edge E15 parallel to the third edge E13, on the side close to the gate line G1.

From the other viewpoint, the pixel electrode PE1 includes a sixth edge E16 opposed to the first edge E11, a seventh edge E17 opposed to the second edge E12, an eighth edge E18 opposed to the third edge E13, and a ninth edge E19 opposed to the fourth edge E14. The sixth to ninth edges E16 to E19 correspond to, for example, the inner peripheral edges of the pixel electrode PE1 and define the slit SL1. The sixth edge E16 and the seventh edge E17 extend in the first extending direction D11, and also extend parallel to the source lines S1 and S2. The eighth edge E18 and the ninth edge E19 extend in the first direction X, and also extend parallel to the gate lines G1 and G2.

Next, the configuration will be explained with reference to a pixel electrode PE2 surrounded by the gate lines G2 and G3, and the source lines S1 and S2. The pixel electrode PE2 is shaped in line symmetry with the pixel electrode PE1 with respect to the gate line G2. For this reason, the shape of the pixel electrode PE2 will be explained briefly.

The pixel electrode PE2 includes an outer peripheral edge including a first edge E21 located on the source line S1 side, a second edge E22 located on the source line S2 side, a third edge E23 located on the gate line G2 side, and a fourth edge E24 located on the gate line G3 side. The first edge E21 and the second edge E22 extend in a first extending direction D21. The third edge E23 and the fourth edge E24 extend in a second extending direction D22. The first extending direction D21 and the second extending direction D22 are directions intersecting the first direction X, at an acute angle clockwise. Furthermore, a first angle θ1 formed between the first direction X and the first extending direction D21 is greater than a second angle θ2 formed between the first direction X and the second extending direction D22.

A first interval on the source line S1 side between the gate line G2 and the third edge E23 is smaller than a second interval on the source line S2 side between the gate line G2 and the third edge E23, though reference numerals are omitted in the drawing. In addition, a third interval on the source line S1 side between the gate line G3 and the fourth edge E24 is greater than a fourth interval on the source line S2 side between the gate line G3 and the fourth edge E24. The source lines S1 and S2 extend in the first extending direction D21, at positions on both sides sandwiching the pixel electrode PE2.

The pixel electrode PE2 includes a first portion P21 including the first edge E21, a second portion P22 including the second edge E22, a third portion P23 including the third edge E23, and a fourth portion P24 including the fourth edge E24. In the drawing, the first portion P21 and the second portion P22 correspond to portions represented by oblique lines downward to the right side, and the third portion P23 and the fourth portion P24 correspond to portions represented by oblique lines upward to the right side. End portions of each of the third portion P23 and the fourth portion P24 are connected to the first portion P21 and the second portion P22. A longer axis of the slit SL2 of the pixel electrode PE2 extends in the first extending direction D21.

The width in the second direction Y, of the third portion P23, is decreased from the source line S1 side toward the source line S2 side in the first direction X. The width in the second direction Y, of the fourth portion P24, is increased from the source line S1 side toward the source line S2 side in the first direction X. None of the third portion P23 and the fourth portion P24 protrudes toward the side close to the source line S1 beyond the first portion P21 or protrudes toward the side close to the source line S2 beyond the second portion P22.

In the pixel electrode PE2, a first interior angle θ21 formed between the first edge E21 and the third edge E23, and a fourth interior angle θ24 formed between the second edge E22 and the fourth edge E24 are acute angles and are, for example, equal to each other. In addition, a second interior angle θ22 formed between the second edge E22 and the third edge E23, and a third interior angle θ23 formed between the first edge E21 and the fourth edge E24 are obtuse angles and are, for example, equal to each other.

In the pixel electrode PE2, the third portion P23 is opposed to a relay electrode RE2 in the X-Y plane. The relay electrode RE2 comprises a fifth edge E25 parallel to the third edge E23, on the side close to the gate line G2. The pixel electrode PE2 includes inner peripheral edges, similarly to the pixel electrode PE1, but its illustration and explanation are omitted.

In the example shown in FIG. 5, the source lines S1 and S2 are curved in accordance with the shape of the pixel electrodes PE1 and PE2, but may be shaped in a straight line along the second direction Y.

Next, the operations of the liquid crystal display device having the above-explained configuration will be explained. First, a case where the liquid crystal layer LQ is composed of the negative liquid crystal material will be explained.

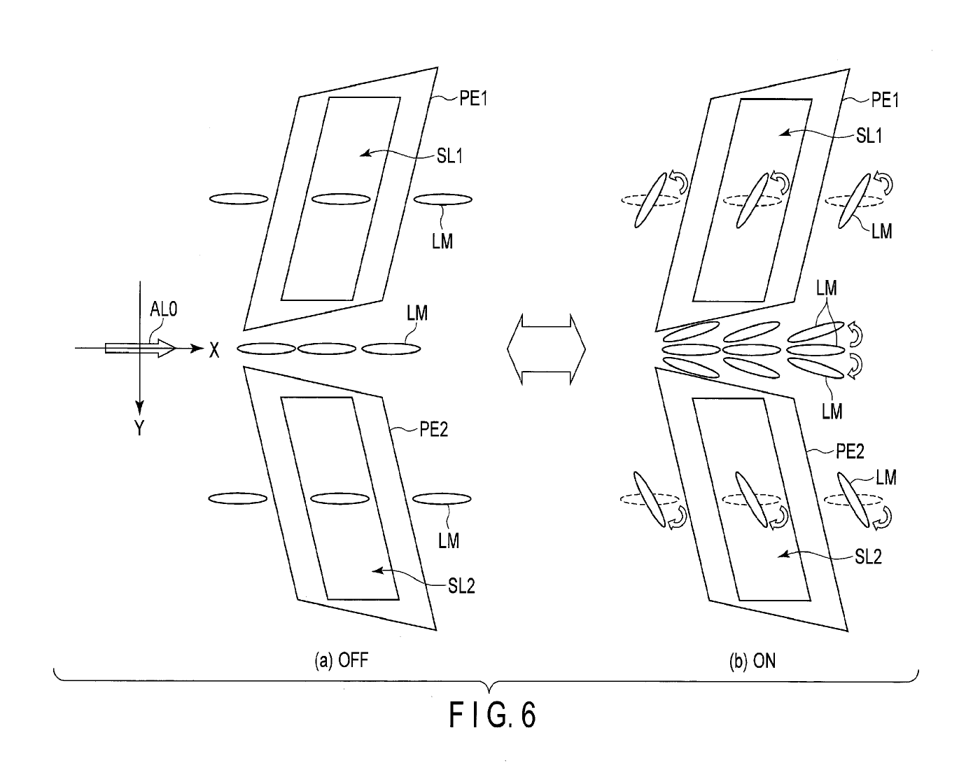

FIG. 6(a) shows a state in which a voltage is not applied to the liquid crystal layer LQ, i.e., an alignment state of the liquid crystal molecules LM at an OFF time at which an electric field is not formed between the pixel electrodes PE1 and PE2, and the common electrode CE. In other words, the longer axis of the liquid crystal molecules LM is subjected to initial alignment in a direction parallel to the first direction X, in the X-Y plane. The state at the OFF time corresponds to the initial alignment state, and the alignment direction of the liquid crystal molecules LM at the OFF time corresponds to an initial alignment direction AL0. The initial alignment state is implemented by aligning the first alignment film AL1 and the second alignment film AL2 in the first direction X. A method of the alignment treatment may be a rubbing treatment or an optical alignment treatment. In the example illustrated, the liquid crystal molecules LM are subjected to initial alignment along the first direction X, in the surrounding of the pixel electrodes PE1 and PE2 and in the slits SL1 and SL2.

At the OFF time, part of light from the backlight unit BL passes through the first polarizer PL1 and is made incident on the display panel PNL. The light made incident on the display panel PNL is linearly polarized light which is orthogonal to the first polarization axis (or absorption axis) AX1 of the first polarizer PL1. The polarization state of the linearly polarized light is hardly varied when the light has passed through the liquid crystal layer LQ at the OFF time. For this reason, the linearly polarized light which has passed through the display panel PNL is absorbed by the second polarizer PL2 having crossed-Nicol relationship with the first polarizer PL1 (black display).

FIG. 6(b) shows a state in which a voltage is applied to the liquid crystal layer LQ, i.e., an alignment state of the liquid crystal molecules LM at an ON time at which an electric field is formed between the pixel electrodes PE1 and PE2, and the common electrode CE. In the drawing, a broken line indicates the initial alignment state of the liquid crystal molecules LM and an arrow indicates a direction of rotation of the liquid crystal molecules LM in the initial alignment direction AL0. At the ON time, an electric field is formed between the pixel electrodes PE1 and PE2, and the common electrode CE, in the X-Y plane. The electric field is formed along the edges of the pixel electrodes PE1 and PE2, and a direction of the electric field is substantially orthogonal to the edges. The liquid crystal molecules LM are affected by the formed electric field, and their alignment state is varied. In the example illustrated, in the surrounding of the pixel electrode PE1 and in the slit SL1, the liquid crystal molecules LM are rotated counterclockwise with respect to the initial alignment direction AL0, and aligned such that their longer axis is oriented in a direction substantially parallel to the edges of the pixel electrode PE1. In addition, in the surrounding of the pixel electrode PE2 and in the slit SL2, the liquid crystal molecules LM are rotated clockwise with respect to the initial alignment direction AL0, and aligned such that their longer axis is oriented in a direction substantially parallel to the edges of the pixel electrode PE2. The liquid crystal molecules LM located near the pixel electrode PE1, between the pixel electrodes PE1 and PE2, are rotated counterclockwise, the liquid crystal molecules LM located near the pixel electrode PE2 are rotated clockwise, and the liquid crystal molecules LM located in the middle of the pixel electrodes PE1 and PE2 are maintained in the initial alignment state. Since the region between the pixel electrodes PE1 and PE2 corresponds to the region opposed to the gate line G2 as shown in FIG. 5 and is also the region overlaid on the light-shielding layer SH as explained above, the region hardly contributes to the display.

At the ON time, the polarization state of linearly polarized light made incident on the display panel PNL is varied in accordance with the alignment state of the liquid crystal molecules LM when the light passes through the liquid crystal layer LQ. For this reason, at least part of the light which has passed through the liquid crystal layer LQ is transmitted through the second polarizer PL2 at the ON time (white display).

Since the pixel electrodes PE1 and PE2 are opposed to the common electrode CE via the fifth insulating film 15, the pixel potential written in each pixel is held between the electrodes for a certain period, at the ON time.

Next, the operations of the liquid crystal display device in a case where the liquid crystal layer LQ is composed of the positive liquid crystal material will be explained.

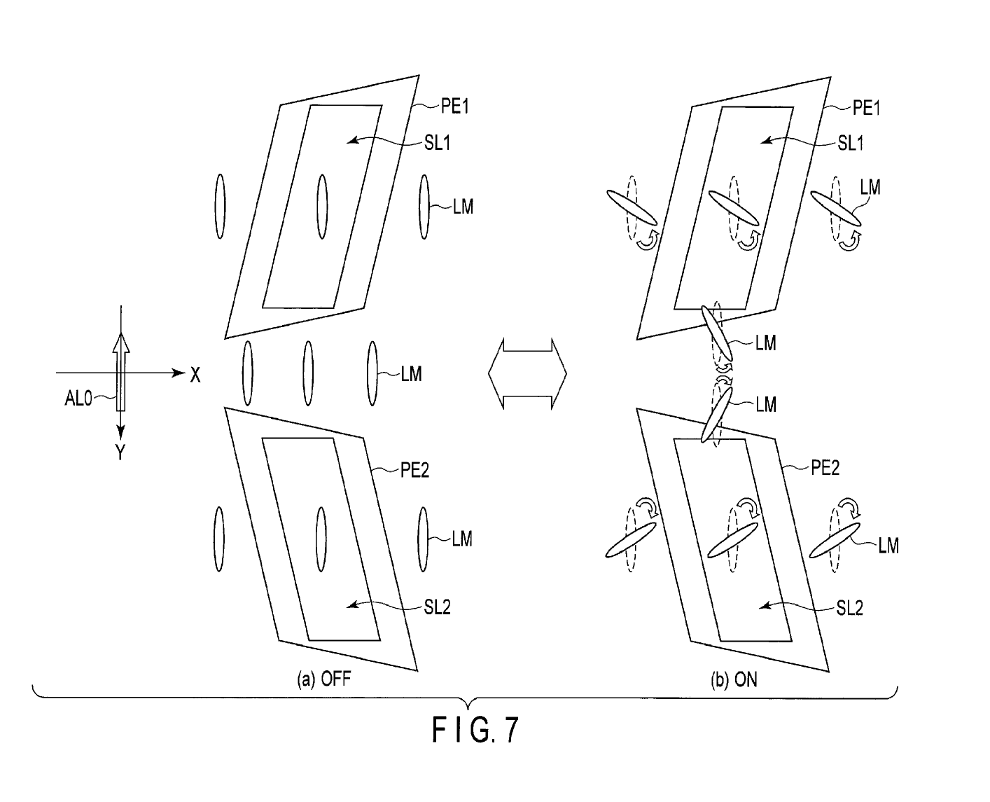

FIG. 7(a) shows the alignment state of the liquid crystal molecules LM at the OFF time. The longer axis of the liquid crystal molecules LM is subjected to initial alignment in a direction parallel to the second direction Y, in the X-Y plane. In the example illustrated, the liquid crystal molecules LM are subjected to initial alignment along the second direction Y, in the surrounding of the pixel electrodes PE1 and PE2 and in the slits SL1 and SL2. In other words, the initial alignment direction AL0 is parallel to the second direction Y. At the OFF time, the linearly polarized light made incident on the display panel PNL is absorbed by the second polarizer PL2 having crossed-Nicol relationship with the first polarizer PL1, similarly to the case explained with reference to FIG. 6(a), since the polarization state of the linearly polarized light is hardly varied when the linearly polarized light has passed through the liquid crystal panel LQ at the OFF time (black display).

FIG. 7(b) shows the alignment state of the liquid crystal molecules LM at the ON time. The liquid crystal molecules LM are affected by the formed electric field, and their alignment state is varied. In the example illustrated, in the surrounding of the pixel electrode PE1 and in the slit SL1, the liquid crystal molecules LM are rotated counterclockwise with respect to the initial alignment direction AL0, and aligned such that their longer axis is oriented in a direction substantially orthogonal to the edges of the pixel electrode PE1. In addition, in the surrounding of the pixel electrode PE2 and in the slit SL2, the liquid crystal molecules LM are rotated clockwise with respect to the initial alignment direction AL0, and aligned such that their longer axis is oriented in a direction substantially orthogonal to the edges of the pixel electrode PE2. The liquid crystal molecules LM rotating in mutually opposite directions exist together between the pixel electrodes PE1 and PE2, similarly to the example shown in FIG. 6(b), and such a region hardly contributes to the display since the region is overlaid on the gate line G2 or the light-shielding layer SH.

At the ON time, the polarization state of linearly polarized light made incident on the display panel PNL is varied in accordance with the alignment state of the liquid crystal molecules LM when the light passes through the liquid crystal layer LQ. For this reason, at least part of the light which has passed through the liquid crystal layer LQ is transmitted through the second polarizer PL2 at the ON time (white display).

According to the embodiments, the liquid crystal molecules LM rotate in the same direction based on the initial alignment direction, along the entire periphery of the pixel electrode PE, when the electric field is formed along the outer peripheral edge of the pixel electrode PE. In other words, the alignment restriction force to the liquid crystal molecules LM can be increased since the alignment direction of the liquid crystal molecules LM at the ON time is determined uniquely. Even if a stress to press is applied from the outside, the liquid crystal molecules LM can rotate in a predetermined direction and suppress the non-uniformity in display to firm a desired alignment state.

In addition, since a region where the liquid crystal molecules LM rotating in opposite directions compete does not exist, occurrence of a dark line resulting from propagation of such a region into the opening portions of pixels can be suppressed. The transmittance per pixel can be thereby enhanced.

Deterioration in display quality can be therefore suppressed.

When the present inventor pressed the display screen of the liquid crystal display device of the embodiments with a stylus by load of 200 g weight, moved the stylus, and observed the display screen, he confirmed that a locus of the stylus cannot be visually recognized as the non-uniformity in display.

According to the embodiments, a sufficient interval can be secured to suppress an electric short-circuit between the pixel electrode PE and the adjacent electrode even if pixel pitches (or source line pitches) in the first direction X become smaller, since the alignment restriction force of the liquid crystal molecules LM can be increased without forming protruding portions which protrude toward the source lines S in the pixel electrode PE.

In addition, even if the width of the pixel electrode PE is smaller as the pixel size becomes smaller, redundancy can be increased since the pixel electrode PE is formed in a loop shape. In other words, even if break occurs at a part of the pixel electrode PE, the pixel potential can be supplied to any parts via paths passing through the other parts.

Higher definition can be therefore achieved without reducing yields or reliability.

In addition, the relay electrode RE configured to make electric connection between the pixel electrode PE and the switching element SW is opposed to a part of the pixel electrode PE and includes an edge parallel to an edge of this part. For this reason, the electric field formed between the pixel electrode PE and the common electrode CE can hardly be influenced by the electric field formed between the relay electrode RE and the common electrode CE, and the disturbance in alignment of the liquid crystal molecules LM resulting from the disturbance in the electric field can be suppressed.

Furthermore, the common electrode CE is located more closely to the liquid crystal layer side than to the gate line G and the source line S in the array substrate AR, and opposed to the gate line G and the source line S. For this reason, the liquid crystal layer LQ can be shielded against an undesired leakage field directed from the gate line G and the source line S. Accordingly, influence from an undesired electric field in the region close to the gate line G and the source line S, of the region contributing to the display in each pixel, can be reduced, and the display quality can be improved.

In addition, the pixel electrode PE is opposed to the common electrode CE via the fifth insulating film 15 and can hold the pixel quality written in each pixel for a certain period. The fifth insulating film 15 is formed of, for example, an inorganic material such as silicon nitride. For this reason, the fifth insulating film 15 can be formed to be thinner as compared with the comparison example in which the fifth insulating film 15 is formed of an organic material. In the embodiments, a larger capacitance can be thereby formed easily as compared with the comparative example. For this reason, an auxiliary capacitance line crossing the pixel to form a storage capacitor is unnecessary. Thus, the area of the transmissive region per pixel can be increased and the transmittance can be enhanced as compared with a case where an auxiliary capacitance line is disposed.

Next, another configuration example of the embodiments will be explained. In the descriptions below, main different points will be explained, and the same constituent elements as those in the above-explained example are denoted by the same reference numerals, and their detailed description is omitted.

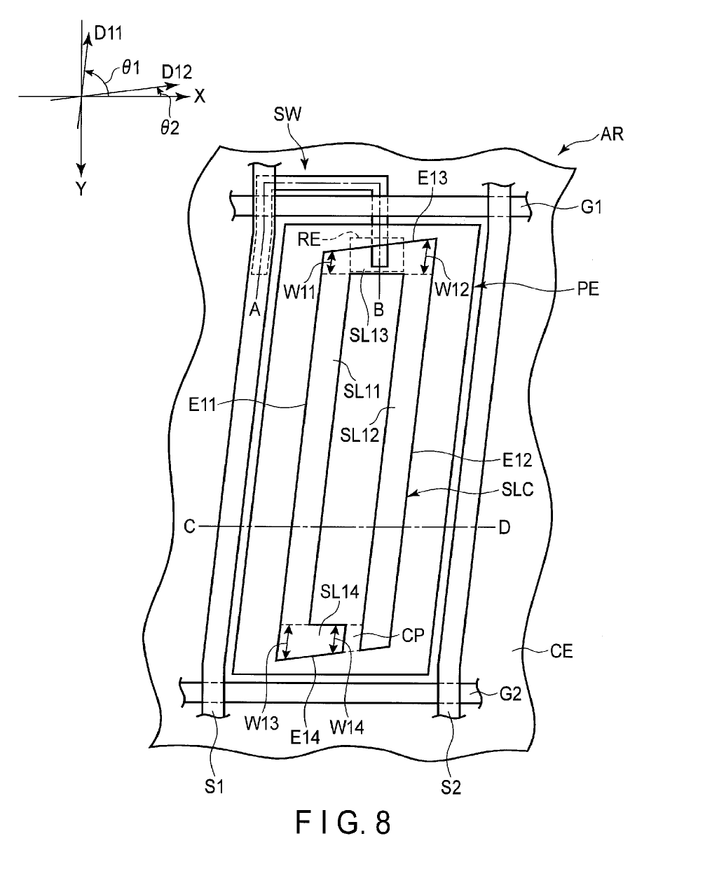

FIG. 8 is a plan view showing another configuration example of the pixel PX on the array substrate AR shown in FIG. 1. The configuration example shown in FIG. 8 is different from the configuration example in FIG. 2 with respect to features that the pixel electrode PE is formed in a flattened shape including no slit and that the common electrode CE is located in an upper level than the pixel electrode PE ands includes a slit SLC.

The pixel electrode PE is located on an inner side surrounded by the gate lines G1 and G2 and the source lines S1 and S2, and formed in an insular shape. The pixel electrode PE is electrically connected with the switching element SW via the relay electrode RE.

The common electrode CE is formed to be located on an upper layer side than and opposed to the gate lines G1 and G2, the source lines S1 and S2, the switching element SW and the pixel electrode PE. The common electrode CE includes the slit SLC opposed to the pixel electrode PE.

The common electrode CE includes the first edge E11 located on the source line S1 side, the second edge E12 located on the source line S2 side, the third edge E13 located on the gate line G1 side, and the fourth edge E14 located on the gate line G2 side. Similarly to the example shown in FIG. 5, the first edge E11 and the second edge E12 extend in the first extending direction D11 while the third edge E13 and the fourth edge E14 extend in the second extending direction D12. The first to fourth edges E11 to E14 correspond to, for example, outer peripheral edges of the slit SLC.

An interval along the second direction Y between the gate line G1 and the third edge E13, an interval along the second direction Y between the gate line G2 and the fourth edge E14, and shapes of the first to fourth edges E11 to E14 are not explained since they are similar to those explained with reference to FIG. 5.

The slit SLC of the common electrode CE will be explained hereinafter in more detail. The common electrode CE includes a first slit SL11 including the first edge E11, a second slit SL12 including the second edge E12, a third slit SL13 including the third edge E13, and a fourth slit SL14 including the fourth edge E14. End portions of the third slit SL13 are connected to the first slit SL11 and the second slit SL12, respectively. The four slit SL14 is cut away in the middle. In the example illustrated, one of end portions of the fourth slit SL14 is connected to the first slit SL11 while the other end portion is separated from the second slit SL12. In other words, the common electrode CE includes a connection portion CP which makes electric connection between the inside portion surrounded by the slit SLC and the outside portion of the slit SLC, between the second slit SL12 and the fourth slit SL14.

The first slit SL11 and the second slit SL12 are arranged in the first direction X to be spaced apart from each other, and extend in the first extending direction D11. Widths in the first direction X, of the first slit SL11 and the second slit SL12, are substantially equal to each other. The third slit SL13 and the fourth slit SL14 extend in the first direction X or the second extending direction D12. The width in the second direction Y, of the third slit SL13, is increased from the source line S1 side toward the source line S2 side in the first direction X. For example, a first width W11 on the source line S1 side, of the third slit SL13 illustrated, is smaller than a second width W12 on the source line S2 side, of the third slit SL13. The width in the second direction Y, of the fourth slit SL14, is increased from the source line S1 side toward the source line S2 side in the first direction X. For example, a third width W13 on the source line S1 side, of the fourth slit SL14 illustrated, is greater than a fourth width W14 on the source line S2 side, of the fourth slit SL14.

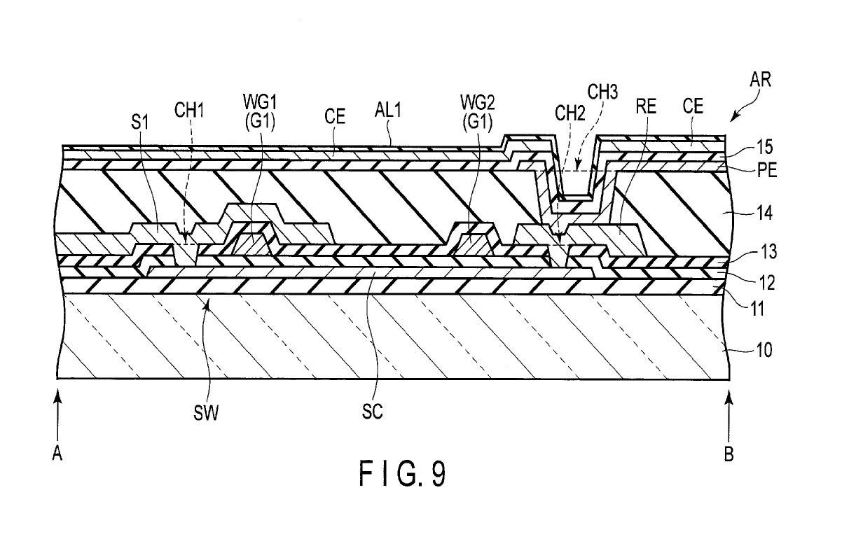

FIG. 9 is a cross-sectional view showing the array substrate AR seen along line A-B of FIG. 8. The configuration example shown in FIG. 9 is different from the configuration example in FIG. 3 with respect to a feature that the pixel electrode PE is located on a side closer to the first insulating substrate 10 than the common electrode CE.

In other words, the pixel electrode PE is formed on the fourth insulating film 14 and is in contact with the relay electrode RE through the contact hole CH3 which penetrates the fourth insulating film 14. The fifth insulating film 15 is formed on the fourth insulating film 14 and the pixel electrode PE. The common electrode CE is formed on the fifth insulating film 15 and covered with the first alignment film AL1. In other words, in the example illustrated, the fourth insulating film 14 corresponds to a first interlayer insulating film, the fifth insulating film 15 corresponds to a second interlayer insulating film, the pixel electrode PE corresponds to a first electrode, and the common electrode CE corresponds to a second electrode.

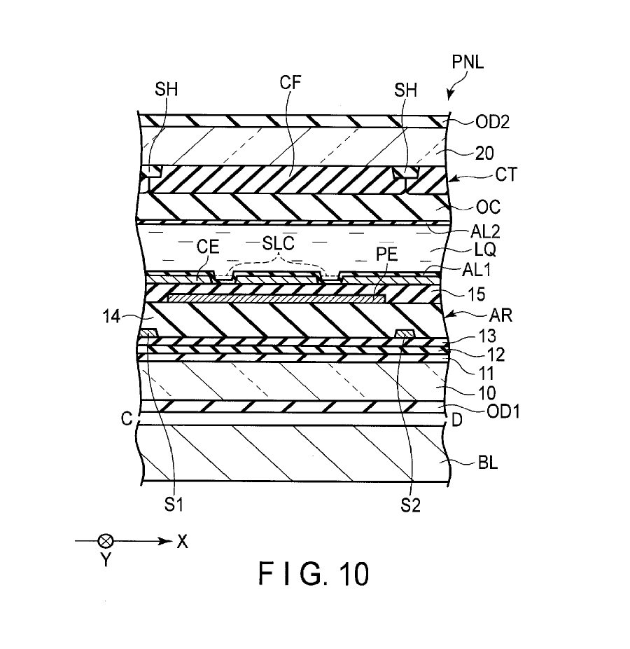

FIG. 10 is a cross-sectional view showing the display panel PNL seen along line C-D of FIG. 8.

In the array substrate AR, the pixel electrode PE is formed on the fourth insulating film 14 and covered with the fifth insulating film 15. The pixel electrode PE is located on an inner side than a position just above the source lines S1 and S2. The common electrode CE is formed on the fifth insulating film 15 and covered with the first alignment film AL1. The common electrode CE is opposed to the pixel electrode PE, extends to a position opposed to the source lines S1 and S2, and also extends to a position opposed to a gate line (not shown).

The configuration of the counter-substrate CT is not explained since it is the same as the configuration example shown in FIG. 4.

The liquid crystal layer LQ is sealed between the first alignment film AL1 and the second alignment film AL2 and formed of a negative liquid crystal material or positive liquid crystal material.

In this configuration example, too, the liquid crystal display device operates in the same manner as that explained with reference to FIG. 6 and FIG. 7. The same advantages as those explained above can be therefore obtained.

In addition, even if a potential difference is generated between adjacent pixel electrodes, the liquid crystal layer LQ is shielded against the electric field generated between the pixel electrodes by the common electrode CE since the common electrode CE is located on a side closer to the liquid crystal layer LQ than to the pixel electrode PE. For this reason, the undesired lateral electric field generated between the adjacent pixel electrodes does not affect the liquid crystal layer LQ, and the disturbance in alignment of the liquid crystal molecules can be suppressed.

In addition, since the plate-like pixel electrode PE including a slit and the common electrode are opposed to each other via the fifth insulating film 15, a comparatively large capacitance can be formed between the pixel electrode PE and the common electrode.

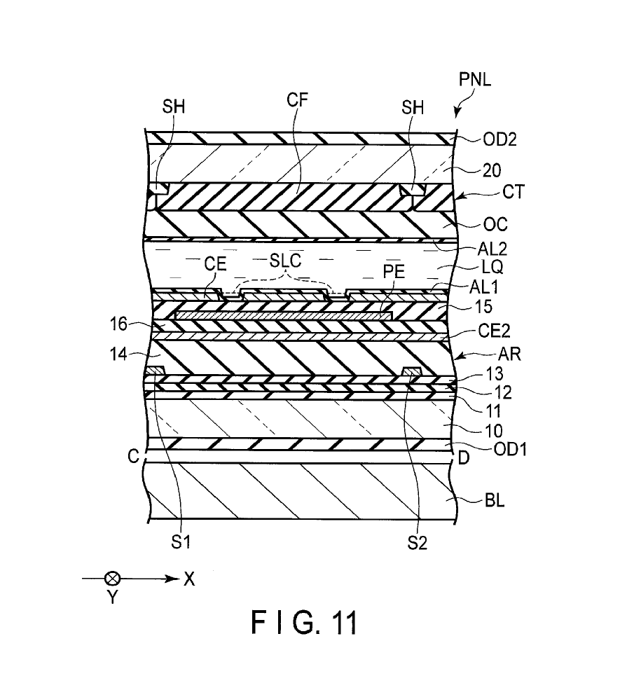

FIG. 11 is another cross-sectional view showing the display panel PNL seen along line C-D of FIG. 8. The configuration example shown in FIG. 11 is different from the configuration example in FIG. 10 with respect to a feature that the array substrate includes a second common electrode CE2 and a sixth insulating film 16 between the fourth insulating film 14 and the pixel electrode PE.

In other words, the second common electrode CE2 is located on the fourth insulating film 14 and covered with the sixth insulating film 16. The sixth insulating film 16 is located between the second common electrode CE2 and the pixel electrode PE. The second common electrode CE2 is formed of a transparent conductive material similarly to the common electrode CE and the like, extends to a position opposed to the source lines S1 and S2, and also extends to a position opposed to a gate line (not shown). The second common electrode CE2 is electrically connected with the common electrode CE and is of the same potential as the common electrode CE. The sixth insulating film 16 is formed of an inorganic material, similarly to the fifth insulating film 15 or the like. In addition, the thickness of the fifth insulating film 15 and the sixth insulating film 16 is smaller than the thickness of the fourth insulating film 14.

In this configuration example, too, the same advantages as those of the above-explained configuration example can be obtained.

In addition, since the second common electrode CE2 is interposed between the pixel electrode PE and the source lines S1 and S2, the capacitive coupling between the pixel electrode PE and the source lines S1 and S2 can be suppressed.

Since the pixel electrode PE is opposed not only to the common electrode CE via the fifth insulating film 15, but also to the second common electrode CE2 via the sixth insulating film 16, a larger capacitance than that of the configuration example shown in FIG. 10 can be formed.

As explained above, the liquid crystal display device capable of suppressing the deterioration in display quality can be provided by the embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device, comprising:
a first substrate including a first gate line and a second gate line, a first source line and a second source line intersecting the first gate line and the second gate line, respectively, a first interlayer insulating film disposed above the first gate line, the second gate line, the first source line and the second source line, a first electrode located above the first interlayer insulating film, a second interlayer insulating film disposed above the first electrode, and a second electrode located above the second interlayer insulating film and opposed to the first electrode;
a second substrate opposed to the first substrate; and
a liquid crystal layer held between the first substrate and the second substrate,
the second electrode including an outer peripheral edge including a first edge located on the first source line side, a second edge located on the second source line side, a third edge located on the first gate line side, and a fourth edge located on the second gate line side,
the first gate line and the second gate line extending in a first direction, the first edge and the second edge extending in a first extending direction, the third edge and the four edge extending in a second extending direction,
the first extending direction and the second extending direction being in a same orientation and intersecting the first direction at an acute angle,
a first angle between the first direction and the first extending direction being greater than a second angle between the first direction and the second extending direction.

2. The liquid crystal display device of claim 1, wherein
the first source line and the second source line extend in the first extending direction.

3. The liquid crystal display device of claim 1, wherein
the first edge is formed parallel to the first source line and connected to the third edge and the fourth edge, and
the second edge is formed parallel to the second source line and connected to the third edge and the fourth edge.

4. The liquid crystal display device of claim 1, wherein
the second electrode has a first interior angle formed between the first edge and the third edge, a second interior angle formed between the second edge and the third edge, a third interior angle formed between the first edge and the fourth edge, and a fourth interior angle formed between the second edge and the fourth edge, and
the first interior angle and the fourth interior angle are obtuse angles, and the second interior angle and the third interior angle are acute angles.

5. The liquid crystal display device of claim 1, wherein
a first interval on the first source line side between the first gate line and the third edge is greater than a second interval on the second source line side between the first gate line and the third edge, and
a third interval on the first source line side between the second gate line and the fourth edge is smaller than a fourth interval on the second source line side between the second gate line and the fourth edge.

6. The liquid crystal display device of claim 1, wherein
the first substrate further includes a switching element electrically connected with the first gate line and the first source line,
the switching element comprises a relay electrode electrically connected with the second electrode, and
the second electrode includes a first portion including the first edge, a second portion including the second edge, a third portion including the third edge and connected with the first portion and the second portion, and a fourth portion including the fourth edge and connected with the first portion and the second portion.

7. The liquid crystal display device of claim 6, wherein
the relay electrode includes a fifth edge formed parallel to the third edge and opposed to the third portion.

8. The liquid crystal display device of claim 6, wherein
a first width on the first source line side of the third portion is smaller than a second width on the second source line side of the third portion, and
a third width on the first source line side of the fourth portion is greater than a fourth width on the second source line side of the fourth portion.

9. The liquid crystal display device of claim 1, wherein
the first substrate further includes a switching element electrically connected with the first gate line and the first source line,
the switching element comprises a relay electrode electrically connected with the first electrode, and
the second electrode includes a first slit including the first edge, a second slit including the second edge, a third slit including the third edge, and a fourth slit including the fourth edge.

10. The liquid crystal display device of claim 9, wherein
the fourth slit connected with any one of the first slit and the second slit.

11. The liquid crystal display device of claim 9, wherein
a first width on the first source line side of the third slit is smaller than a second width on the second source line side of the third slit, and
a third width on the first source line side of the fourth slit is greater than a fourth width on the second source line side of the fourth slit.

12. The liquid crystal display device of claim 9, wherein
the first substrate further includes a third electrode located above the first interlayer insulating film and a third interlayer insulating film located between the third electrode and the first electrode, and
the third electrode has a same potential as the second electrode.

13. The liquid crystal display device of claim 12, wherein
the third electrode is opposed to the first gate line, the second gate line, the first source line and the second source line via the first interlayer insulating film.

14. The liquid crystal display device of claim 12, wherein
the first interlayer insulating film is formed of an organic material, and each of the second interlayer insulating film and the third interlayer insulating film is formed of an inorganic material and has a thickness smaller than the first interlayer insulating film.

15. The liquid crystal display device of claim 1, wherein
two second electrodes identical with the second electrode, adjacent to each other in the second direction to sandwich the second gate line, are shaped in a line symmetry with respect to the second gate line.

16. The liquid crystal display device of claim 1, wherein
the second electrode includes an inner peripheral edge including a sixth edge opposed to the first edge, a seventh edge opposed to the second edge, an eighth edge opposed to the third edge and extending parallel to the first gate line, and a ninth edge opposed to the fourth edge and extending parallel to the second gate line.

17. A liquid crystal display device, comprising:
a first substrate including a first gate line and a second gate line parallel to each other, and a second electrode located between the first gate line and the second gate line;
a second substrate opposed to the first substrate; and
a liquid crystal layer held between the first substrate and the second substrate,
the second electrode including an outer peripheral edge including a first edge and a second edge parallel to each other, a third edge connected to the first edge and the second edge and located on the first gate line side, and a fourth edge connected to the first edge and the second edge and located on the second gate line side,
the third edge and the fourth edge being parallel to each other and nonparallel to the first gate line and the second gate line.

18. The liquid crystal display device of claim 17, wherein
the first substrate further includes a fourth electrode adjacent to the second electrode so as to sandwich the second gate line, and
the second electrode and the fourth electrode are shaped in a line symmetry with respect to the second gate line.
